(19) United States
(12) Patent Application Publication
(10) Pub. No.: US 2026/0056724 A1
(43) Pub. Date: Feb. 26, 2026

(54) REFLECTION AUGMENTED CODE TRANSLATION

(71) Applicant: INTERNATIONAL BUSINESS MACHINES CORPORATION, Armonk, NY (US)

(72) Inventors: Deepak E D, Coppell, TX (US); Ravi Bhupathiraju, Allen, TX (US)

(21) Appl. No.: 18/810,023

(22) Filed: Aug. 20, 2024

(51) Int. Cl. G06F 8/51; G06F 8/41

(52) U.S. Cl. CPC G06F 8/51; G06F 8/433

(57) ABSTRACT

Methods and systems for code translation include translating original data structures from original code in a first programming language to translated data structures in a second programming language using a language model. The original code is divided into a set of functions, each of the set being associated with any corresponding dependencies from the data structures. Each of the set of functions is translated into translated functions in the second programming language, along with the corresponding dependencies, using the language model. An error in the translated functions is corrected assuming correctness of the translated data structures.

### BACKGROUND

The present invention generally relates to automated code translation and, more particularly, to code translation that uses reflection techniques to improve translation quality.

Many critical systems, including government, financial, and utility computer systems, run on aging legacy software. In some cases these software applications have been in place for many decades and were developed using programing languages and runtime environments that few people have the skills to maintain. Migrating and rewriting such software to modern programing languages and runtime systems may be challenging, as they represent large code bases that have been tuned over the course of many decades. Translating source code to a new programming language environment is a time consuming, labor-intensive process.

### SUMMARY

A method for code translation includes translating original data structures from original code in a first programming language to translated data structures in a second programming language using a language model. The original code is divided into a set of functions, each of the set being associated with any corresponding dependencies from the data structures. Each of the set of functions is translated into translated functions in the second programming language, along with the corresponding dependencies, using the language model. An error in the translated functions is corrected assuming correctness of the translated data structures.

A computer program product includes one or more computer-readable storage media and program instructions stored on the one or more storage media to perform operations. The operations include translating original data structures from original code in a first programming language to translated data structures in a second programming language using a language model, dividing the original code into a set of functions, each of the set being associated with any corresponding dependencies from the data structures, translating each of the set of functions into translated functions in the second programming language, along with the corresponding dependencies, using the language model, and correcting an error in the translated functions assuming correctness of the translated data structures.

A computer system includes a processor set, one or more computer-readable storage media, and program instructions stored on the one or more storage media to cause the processor set to perform operations. The operations include translating original data structures from original code in a first programming language to translated data structures in a second programming language using a language model, dividing the original code into a set of functions, each of the set being associated with any corresponding dependencies from the data structures, translating each of the set of functions into translated functions in the second programming language, along with the corresponding dependencies, using the language model, and correcting an error in the translated functions assuming correctness of the translated data structures.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block/flow diagram illustrating reflection augmented code translation, in accordance with an embodiment of the present invention;

FIG. 2 is a block/flow diagram illustrating a method for reflection augmented code translation, showing the division of original code into functions and their respective dependencies, in accordance with an embodiment of the present invention;

FIG. 3 is a block diagram of a computing environment that can perform reflection augmented code translation, in accordance with an embodiment of the present invention;

FIG. 4 is a diagram illustrating a neural network architecture that can be used to implement part of a language model, in accordance with an embodiment of the present invention; and

FIG. 5 is a diagram illustrating a deep neural network architecture that can be used to implement part of a language model, in accordance with an embodiment of the present invention.

### DETAILED DESCRIPTION

Large language models (LLMs) can translate computer program source code from an original programming language into a target programming language. This makes it possible to rapidly translate legacy code to a new software environment. However, language models suffer from poor accuracy and can generate code that fails to perfectly replicate the functionality of the original code. This can have very negative effects, particularly when the computer program in question runs a system that handles public safety or financial functions. Additionally, the amount of context that can be provided to the LLM is limited to a predetermined number of tokens.

To ensure that translated code performs its function safely and accurately, translated code may be reviewed using code reflection techniques. Correspondences between the original code and the translated code may be established first on the level of data structures. Individual functions or methods within the code can then be handled with a relatively limited context, using only that code which is used by the function in question. This helps to break the body of code up into smaller pieces that can be handled by the LLM, without losing important context. The translated code can be validated against the original code by ensuring that data elements match.

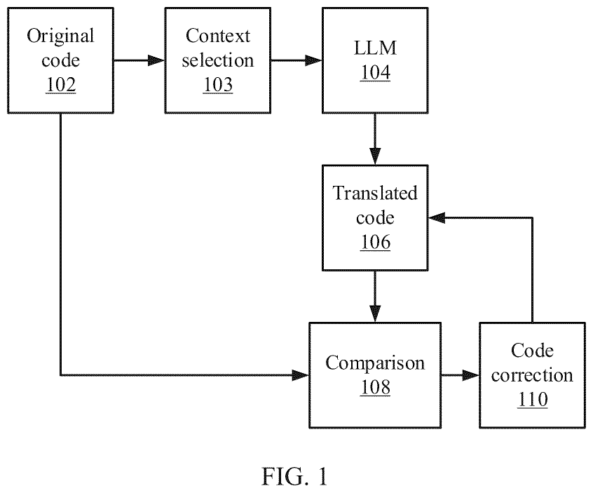

Referring now to FIG. 1, code translation is shown that uses reflection techniques to correct incorrectly translated code. The original program code 102 is written in a first programming language. An LLM 104 is used to translate the original code 102 into a second programming language, generating translated code 106. The LLM may be any appropriately trained language model, such as a general purpose LLM or a language model that has specifically been trained on code translation tasks.

Rather than providing the entire original code 102 to the LLM 104 at once, the original code may be broken up into parts by context selection 103. For example, data structures of the original code 102 may be translated first, followed by individual functions and any data structures and functions that they depend on. This process may continue until each part of the original code 102 has been translated.

After the translation is performed, a comparison 108 between the original code 102 and the translated code 106 is performed. As will be described in greater detail below, this comparison 108 identifies points where the data elements between the original code 102 and the translated code 106 differ. Code correction 110 is then performed to correct discrepancies between the original code 102 and the translated code 106.

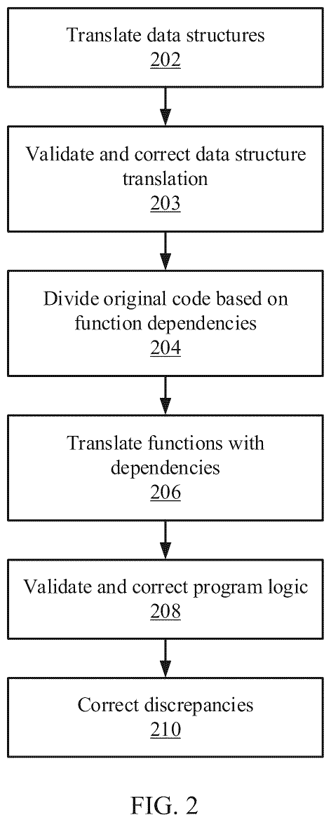

Referring now to FIG. 2, a method of code translation is shown. Block 202 translates the data structures of the original code using LLM 104. Block 203 validates the translation of the data structures. This validation may use a set of predefined rules, for example to ensure that the translated data structures do not include static variables or inner classes. Other rules may include checking the number of variables or structures and ensuring consistency between variable types. Block 203 may further correct any errors in the data structure translation. For example, the LLM 104 may be prompted again to correct any problematic data structures, such as those which are identified as breaking the predefined rules. This process may be repeated until the LLM 104 generates translated data structures that pass the validation.

Once the data structures have been correctly translated, block 204 divides the original code 102 based on function dependencies. Each method, function, or process within the original code 102 is identified, along with any data structures and other functions that it calls. In some cases, the identification of dependencies may be performed automatically with a suitable prompt to the LLM 104, for example asking it to identify data elements used by the function.

Block 206 translates each of the functions of the original code 102 using the LLM 104, providing for each the data structures and other functions that it depends on as context. In some cases, the context may be made up of the translated versions of the data structures. Block 208 validates the program logic of the translated code 106, for example checking the translated functions for whether variables are mapped to the correct objects and whether any variables are spelled incorrectly. Because the data structures were previously validated in block 203, they are treated as trustworthy during the validation of the program logic in block 208. Block 210 then performs any corrections on the translated code 106.

During the validation of block 208, the original code 102 is compared to the translated code 106 to determine whether any variables are mapped to the wrong object. For example, a given function may access two different data structures. For example, consider a function that declares variables:
className1 var1;
className2 var2;

The data structure className1 may have data elements a, b, and c, while className2 may have data elements d, e, and f. One example of a mistranslation would be to attempt to access var1.d, where the data element d belongs to the second class but the element var1 belongs to the first class. Block 210 may correct this problem by altering the translated code 106 to refer to the correct data element based on what the original code 102 calls for.

In another example of code mistranslation, the LLM 104 may output translated code 106 that misspells or mis-capitalizes the name of a data element. In the event that block 208 detects a translated data element which does not correspond to any data element of the already-validated data structures, block 210 may modify that translated data element to match a most-similar data element from the data structures. For example, the similarity between the mistranslated data element and the data elements declared in the data structures may be determined according to an edit distance or any other appropriate similarity metric. Further examples of code mistranslation include the generation of empty classes and skipped objects in a chain.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

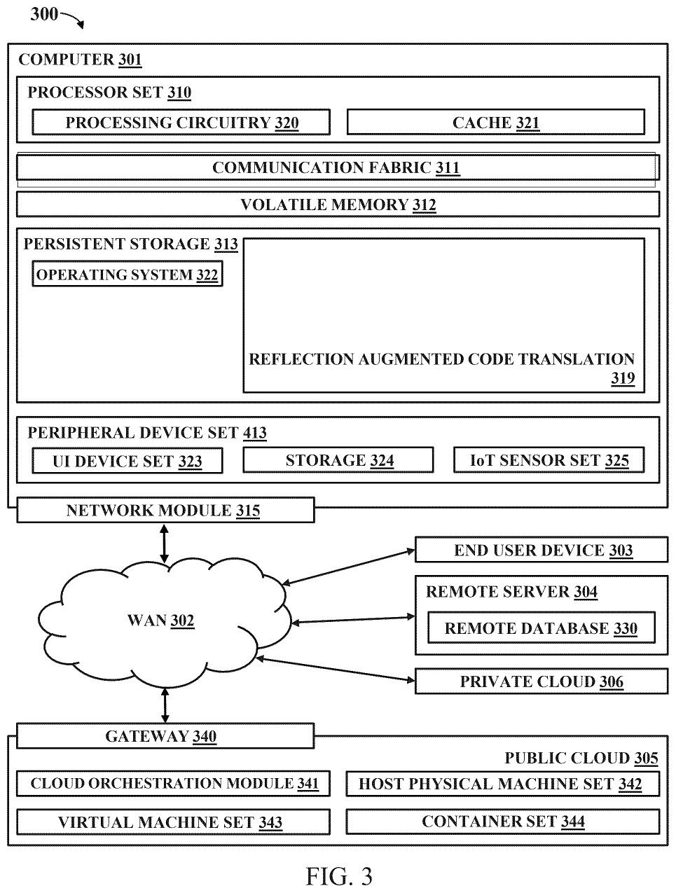

Referring now to FIG. 3, a computing environment 300 shows an example of an environment for the execution of at least some of the computer code involved in performing the inventive methods, such as reflection augmented code translation 319. In addition to block 319, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 319, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 319 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 319 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315. WAN 302 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

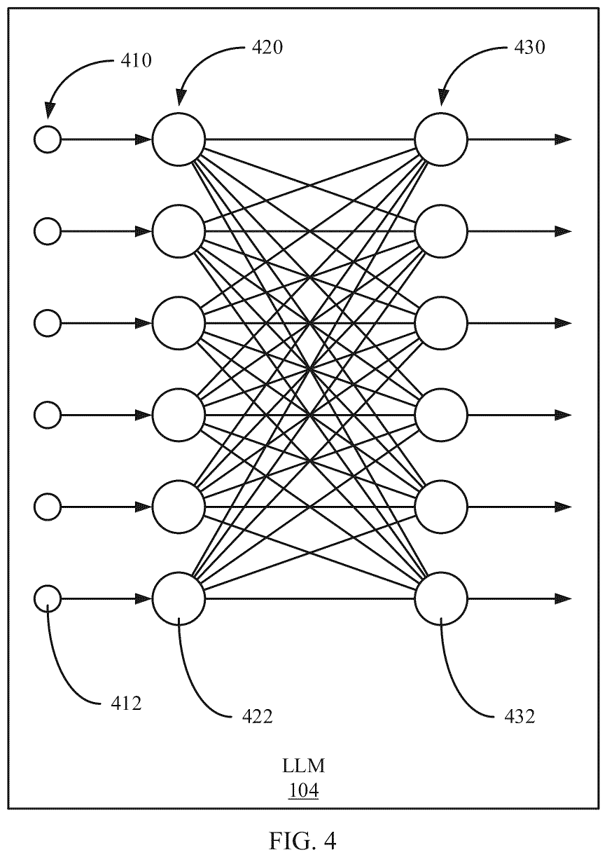

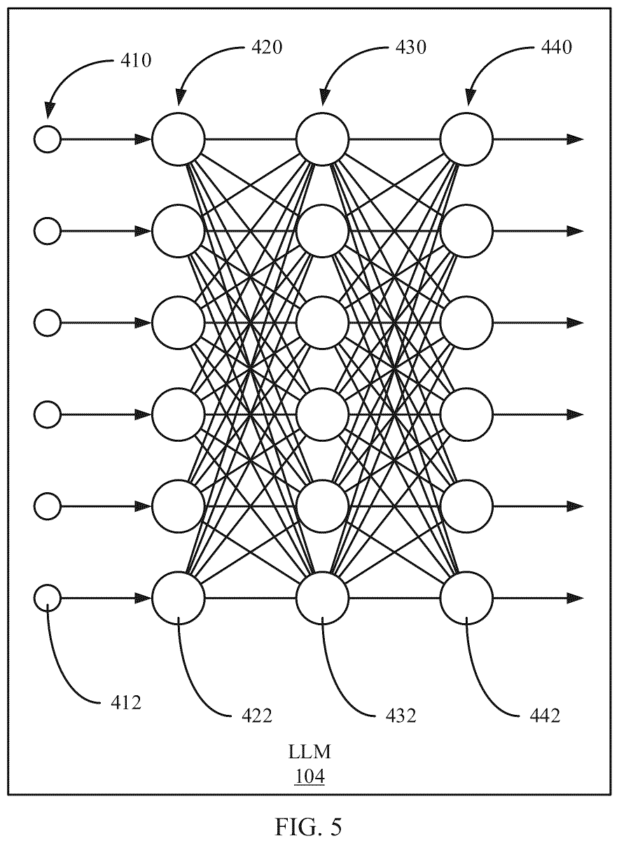

Referring now to FIGS. 4 and 5, exemplary neural network architectures are shown, which may be used to implement parts of the present models, such as LLM 104. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 420 of source nodes 422, and a single computation layer 430 having one or more computation nodes 432 that also act as output nodes, where there is a single computation node 432 for each possible category into which the input example could be classified. An input layer 420 can have a number of source nodes 422 equal to the number of data values 412 in the input data 410. The data values 412 in the input data 410 can be represented as a column vector. Each computation node 432 in the computation layer 430 generates a linear combination of weighted values from the input data 410 fed into input nodes 420, and applies a non-linear activation function that is differentiable to the sum. The exemplary simple neural network can perform classification on linearly separable examples (e.g., patterns).

A deep neural network, such as a multilayer perceptron, can have an input layer 420 of source nodes 422, one or more computation layer(s) 430 having one or more computation nodes 432, and an output layer 440, where there is a single output node 442 for each possible category into which the input example could be classified. An input layer 420 can have a number of source nodes 422 equal to the number of data values 412 in the input data 410. The computation nodes 432 in the computation layer(s) 430 can also be referred to as hidden layers, because they are between the source nodes 422 and output node(s) 442 and are not directly observed. Each node 432, 442 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . w_{n-1,} wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of reflection augmented code translation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for code translation, comprising:
translating original data structures from original code in a first programming language to translated data structures in a second programming language using a language model;
dividing the original code into a set of functions, each of the set being associated with any corresponding dependencies from the data structures;
translating each of the set of functions into translated functions in the second programming language, along with the corresponding dependencies, using the language model; and
correcting an error in the translated functions assuming correctness of the translated data structures.

2. The method of claim 1, wherein a number of tokens of each function of the set of functions and its corresponding dependencies is below a prompt token limit for the language model.

3. The method of claim 1, wherein correcting the error includes correcting a variable in the translated functions that is mapped to an incorrect data element as compared to the original code.

4. The method of claim 1, wherein correcting the error includes correcting spelling of a variable in the translated functions based on a similarity to a data element of the translated data structures.

5. The method of claim 1, wherein correcting the error includes filling an empty class in the translated functions.

6. The method of claim 1, wherein correcting the error includes correcting a chain of objects in the translated functions.

7. The method of claim 1, further comprising validating the translated data structures according to a rule before translating each of the set of functions.

8. The method of claim 7, wherein the rule is selected from the group consisting of a rule prohibiting inner classes and a rule prohibiting static variables.

9. The method of claim 7, further comprising correcting an error in the translated data structures based on the rule.

10. The method of claim 1, wherein translating each of the set of functions includes using translated version of the corresponding dependencies as context for the language model.

11. The method of claim 1, further comprising identifying the corresponding dependencies using a query to the language model.

12. A computer program product, comprising:
one or more computer-readable storage media; and
program instructions stored on the one or more storage media to perform operations comprising:
translating original data structures from original code in a first programming language to translated data structures in a second programming language using a language model;
dividing the original code into a set of functions, each of the set being associated with any corresponding dependencies from the data structures;
translating each of the set of functions into translated functions in the second programming language, along with the corresponding dependencies, using the language model; and
correcting an error in the translated functions assuming correctness of the translated data structures.

13. A computer system, comprising:
a processor set;
one or more computer-readable storage media; and
program instructions stored on the one or more storage media to cause the processor set to perform operations comprising:
translating original data structures from original code in a first programming language to translated data structures in a second programming language using a language model;
dividing the original code into a set of functions, each of the set being associated with any corresponding dependencies from the data structures;
translating each of the set of functions into translated functions in the second programming language, along with the corresponding dependencies, using the language model; and
correcting an error in the translated functions assuming correctness of the translated data structures.

14. The computer system of claim 13, wherein the operations further comprise validating the translated data structures according to a rule before translating each of the set of functions and further comprise correcting an error in the translated data structures based on the rule.

15. The computer system of claim 13, wherein a number of tokens of each function of the set of functions and its corresponding dependencies is below a prompt token limit for the language model.

16. The computer system of claim 13, wherein correcting the error includes correcting a variable in the translated functions that is mapped to an incorrect data element as compared to the original code.

17. The computer system of claim 13, wherein correcting the error includes correcting spelling of a variable in the translated functions based on a similarity to a data element of the translated data structures.

18. The computer system of claim 13, wherein correcting the error includes filling an empty class in the translated functions.

19. The computer system of claim 13, wherein correcting the error includes correcting a chain of objects in the translated functions.

20. The computer system of claim 13, wherein translating each of the set of functions includes using translated version of the corresponding dependencies as context for the language model.
